(19) United States
(12) Patent Application Publication
(10) Pub. No.: US 2026/0115755 A1
(43) Pub. Date: Apr. 30, 2026

(54) DEVICES FOR MULTI-LAYER SLOT DIE COATING AND COATING METHODS

(71) Applicant: QUZHOU MICROQUANTA RENEWABLE ENERGY TECHN. CO., LTD., Quzhou (CN)

(72) Inventors: Buyi YAN, Quzhou (CN); Jizhong YAO, Quzhou (CN); Ye WU, Quzhou (CN)

(73) Assignee: QUZHOU MICROQUANTA RENEWABLE ENERGY TECHN. CO., LTD., Quzhou (CN)

(21) Appl. No.: 19/012,917

(22) Filed: Jan. 8, 2025

(30) Foreign Application Priority Data
Oct. 31, 2024 (CN) 202411544452.6

(51) Int. Cl. B05C 5/02; B05C 9/06; B05C 9/14

(52) U.S. Cl. CPC B05C 5/0254; B05C 9/06; B05C 9/14

(57) ABSTRACT

Disclosed is a device for multi-layer slot die coating and a coating method. The device comprises a first coating die, a second coating die, and a drying module. One end of the first coating die is connected with a first paste. The other end of the first coating die is configured to coat the first paste onto a substrate to form a first coating layer. One end of the second coating die is connected with a second paste. The other end of the second coating die is configured to coat the second paste onto the substrate to form a second coating layer. The drying module is disposed between the first coating die and the second coating die to dry a surface of the first coating layer such that a solid coating interface that causes the first coating layer and the second coating layer not to interfere with each other is formed.

### CROSS-REFERENCE TO RELATED APPLICATIONS

This application claims priority to Chinese Application No. 202411544452.6, filed on Oct. 31, 2024, the entire contents of which are incorporated herein by reference.

### TECHNICAL FIELD

The present disclosure relates to the technical field of slot die coating, and in particular to a device for multi-layer slot die coating device and a coating method thereof.

### BACKGROUND

Slot die coating is a pre-metered process technique for uniformly depositing films. As one of the development directions of advanced processing techniques, slot die coating is widely used in various fields such as new energy perovskite solar cells, display materials, lithium battery pole pieces, photoresists, functional films, etc. The slot die is mainly a single-layer coating die. With the technical advancement of slot die coating, double-layer and multi-layer dies are currently used in the market. Compared with the single-layer slot die, the multi-layer slot die can implementing coating of a plurality of coating layers simultaneously, which greatly saves cost and provides more abundant process techniques for new products. However, multi-layer slot die coating has extremely high requirements for the coating paste of each layer. Each material must be compatible with each other in terms of viscosity and surface tension. In addition, some special products require each coating layer to have individual interface characteristics to achieve the optimal performance. Accordingly, the design upgrade and drying technology of the multi-layer slot dies are core technologies. At present, the technique of multi-layer slot die coating on the market carries out the drying operation after the coating is completed, which makes it difficult to meet the requirements for achieving an individual interface on each coating layer.

Therefore, it is desirable to provide a device for multi-layer slot die coating and a coating method thereof to improve the interface characteristics of individual coating layers of multi-layer coating.

### SUMMARY

One or more embodiments of the present disclosure provide a device for multi-layer slot die coating. The device may comprise a first coating die, a second coating die, and a drying module. One end of the first coating die may be connected with a first paste, and the other end of the first coating die may be configured to coat the first paste onto a substrate to form a first coating layer. One end of the second coating die may be connected with a second paste, and the other end of the second coating die may be configured to coat the second paste onto the substrate to form a second coating layer. The second coating layer may be coated on a surface of the first coating layer. The drying module may be disposed between the first coating die and the second coating die and configured to dry the surface of the first coating layer such that a solid coating interface that causes the first coating layer and the second coating layer not to interfere with each other is formed between the first coating layer and the second coating layer. The second coating die, the drying module, and the first coating die may be sequentially arranged along a positive coating direction of the substrate.

In some embodiments, one or more gas inlets may be disposed at one end of the drying module and may be configured to receive an external heated gas. An exhaust vent may be disposed at the other end of the drying module. The exhaust vent may be opposite to the first coating layer and configured to release the external heated gas to dry the surface of the first coating layer.

In some embodiments, the exhaust vent may be provided with a plurality of exhaust vent holes arranged in an array.

In some embodiments, the first coating die may include a first liquid inlet and a first paste tank cavity. The first liquid inlet may be configured to input the first paste. One end of the first paste tank cavity may be connected with the first liquid inlet. A first slot may be formed between the other end of the first paste tank cavity and the drying module. The first slot may be configured to coat the first paste onto the substrate to form the first coating layer. The second coating die may include a second liquid inlet and a second paste tank cavity. The second liquid inlet may be configured to input the second paste. One end of the second paste tank cavity may be connected with the second liquid inlet. A second slot may be formed between the other end of the second paste tank cavity and the drying module. The second slot may be configured to coat the second paste onto the substrate to form the second coating layer.

In some embodiments, a first wedge groove surface may be disposed at a position of the first paste tank cavity that is connected with the first liquid inlet, and a second wedge groove surface may be disposed at a position of the second paste tank cavity that is connected with the second liquid inlet.

In some embodiments, a first pointed portion may be disposed at the other end of the first coating die. The first slot may be disposed at a tip of the first pointed portion. A second pointed portion may be disposed at the other end of the second coating die. The second slot may be disposed at a tip of the second pointed portion.

In some embodiments, the device for multi-layer slot die coating may further comprise a first coating gasket and a second coating gasket. The first coating gasket may be arranged between the first coating die and the drying module. The second coating gasket may be arranged between the second coating die and the drying module.

In some embodiments, the first coating die, the first coating gasket, and the drying module may be fixedly connected through a first fastener. The second coating die, the second coating gasket, and the drying module may be fixedly connected through a second fastener.

In some embodiments, the first coating gasket may be provided with a first tank cavity hole and a first liquid outlet. The first tank cavity hole may be communicated with the first paste tank cavity. One end of the first liquid outlet may be communicated with the first tank cavity hole, and the other end of the first liquid outlet may be opposite to the substrate to form the first slot. The second coating gasket may be provided with a second tank cavity hole and a second liquid outlet. The second tank cavity hole may be communicated with the second paste tank cavity. One end of the second liquid outlet may be communicated with the second tank cavity hole, and the other end of the second liquid outlet may be opposite to the substrate to form the second slot.

In some embodiments, the device for multi-layer slot die coating may further comprise a slot control module. The slot control module may include a base and a moving mechanism. The moving mechanism may be fixedly connected with the base. The moving mechanism may be configured to drive the second coating die, the drying module, and the first coating die to move on the base.

In some embodiments, the device for multi-layer slot die coating may further comprise a limiting member. The limiting member may be configured to constrain positions of the second coating die, the drying module, and the first coating die on the base.

In some embodiments, the device for multi-layer slot die coating may further comprise a heating component. The heating component may be disposed at a bottom of the substrate and configured to cooperate with the drying module to dry the first coating layer.

In some embodiments, the device for multi-layer slot die coating may further comprise a control module. The control module may be electrically connected with the drying module and the heating component. The control module may be configured to: acquire a first paste feature, a first coating thickness, a product requirement, and a coating speed, the first paste feature including a paste viscosity; determine a drying parameter based on the first paste feature, the first coating thickness, the product requirement, and the coating speed; and control at least one of the drying module or the heating component to perform drying based on the drying parameter.

In some embodiments, the control module may be further configured to determine the first coating thickness based on a first slot width, the paste viscosity, the coating speed, and a paste pressure.

One or more embodiments of the present disclosure provide a coating method of a device for multi-layer slot die coating, implemented based on the device for multi-layer slot die coating, comprising: moving the device for multi-layer slot die coating along the positive coating direction of the substrate, the first coating die, the drying module, and the second coating die moving simultaneously; in response to determining that the first coating die moves to a first position of the substrate, the first coating die starting to coating the first coating layer; in response to determining that the drying module moves to the first position, the drying module starting to dry the surface of the first coating layer; in response to determining that the second coating die moves to the first position, the second coating die starting to coat the second coating layer on the surface of the first coating after drying; in response to determining that the first coating die moves to a second position of the substrate, turning off the first coating die to complete coating of the first coating layer; in response to determining that the drying module moves to the second position of the substrate, turning off the drying module to complete drying of the surface of the first coating layer; and in response to determining that the second coating die moves to the second position of the substrate, turning off the second coating die to complete coating of the second coating layer.

In some embodiments, the device for multi-layer slot die coating may further include a heating component and a control module. The control module may be electrically connected with the drying module and the heating component. The in response to determining that the drying module moves to the first position, the drying module starting to dry the surface of the first coating layer may include: acquiring a first paste feature, a first coating thickness, a product requirement, and a coating speed, the first paste feature including a paste viscosity; determining a drying parameter based on the first paste feature, the first coating thickness, the product requirement, and the coating speed; and controlling at least one of the drying module or the heating component to perform drying based on the drying parameter.

In some embodiments, the acquiring a first coating thickness may include: determining the first coating thickness based on a first slot width, the paste viscosity, the coating speed, and a paste pressure.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic structural diagram illustrating an exemplary device for multi-layer slot die coating from a first angle according to some embodiments of the present disclosure;

FIG. 2 is a schematic structural diagram illustrating a device for multi-layer slot die coating from a second angle according to some embodiments of the present disclosure;

FIG. 3 is a schematic diagram illustrating an exploded structure of a device for multi-layer slot die coating according to some embodiments of the present disclosure;

FIG. 4 is a schematic diagram illustrating a coating principle of a device for multi-layer slot die coating according to some embodiments of the present disclosure;

FIG. 5 is a schematic structural diagram illustrating a drying module in FIG. 1;

FIG. 6 is a schematic diagram illustrating a combined structure of a first coating die and a first coating gasket in FIG. 3;

FIG. 7 is a schematic structural diagram illustrating a second coating die in FIG. 3;

FIG. 8 is a schematic structural diagram illustrating a second coating gasket in FIG. 3; and

FIG. 9 is a schematic structural diagram illustrating another exemplary device for multi-layer slot die coating according to some embodiments of the present disclosure.

### REFERENCE SIGNS

10. first coating die; 11. first liquid inlet; 12. first paste tank cavity; 13. first pointed portion; 101. first slot;
20. second coating die; 21. second liquid inlet; 22. second paste tank cavity; 23. second pointed portion; 201. second slot;
30. drying module; 31. gas inlet; 32. exhaust vent;
40. substrate; 41. first coating layer; 42. second coating layer;
50. first coating gasket; 51. first tank cavity hole; 52. first liquid outlet;
60. second coating gasket; 61. second tank cavity hole; 62. second liquid outlet.

### DETAILED DESCRIPTION

In the description of the present disclosure, it should be noted that the terms “center”, “upper”, “lower”, “left”, “right”, “front”, “rear”, “vertical”, “horizontal”, “inside”, “outside”, or the like, indicate positions or positional relationships based on the positions or positional relationships shown in the drawings, and are only for the convenience of describing the present disclosure and simplifying the description, instead of indicating or implying that the device or element referred to must have a specific orientation, be constructed and operated in a specific orientation, and therefore cannot be understood as a limitation on the present disclosure; the terms “first”, “second”, and “third” are only used for descriptive purposes and cannot be understood as indicating or implying relative importance; in addition, unless otherwise clearly specified and limited, the terms “mounting”, “connected”, and “connecting” should be understood in a broad sense, for example, it can be a fixed connection, a detachable connection, or an integral connection; it can be a direct connection, or an indirect connection through an intermediate medium, or it can be a connection between the two components. For those having ordinary skills in the art, the specific meanings of the terms in the present disclosure can be understood according to specific circumstances.

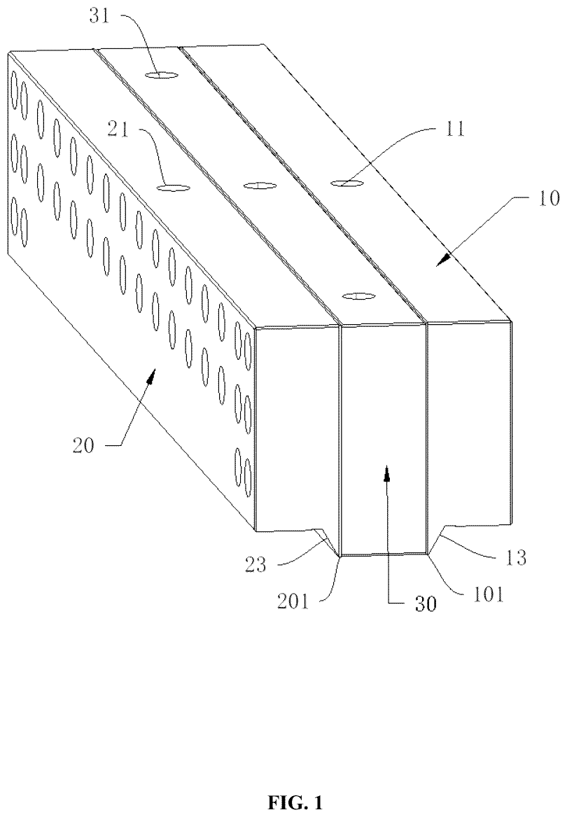

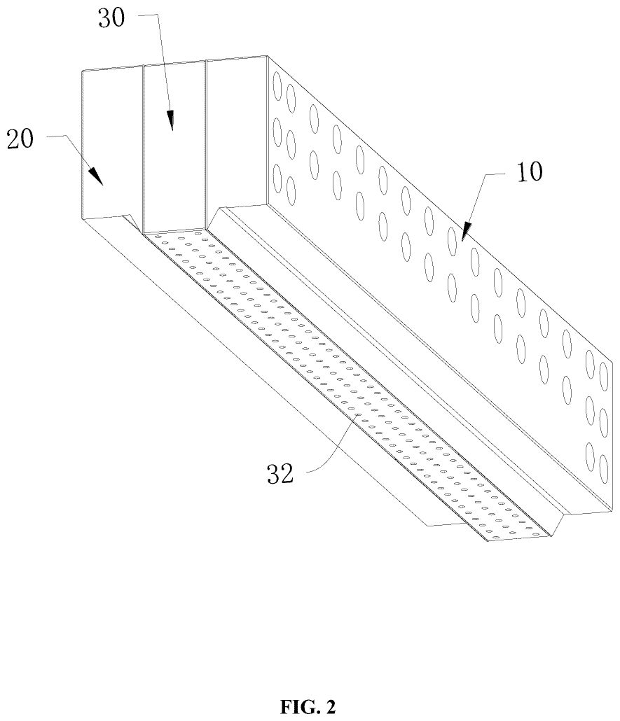

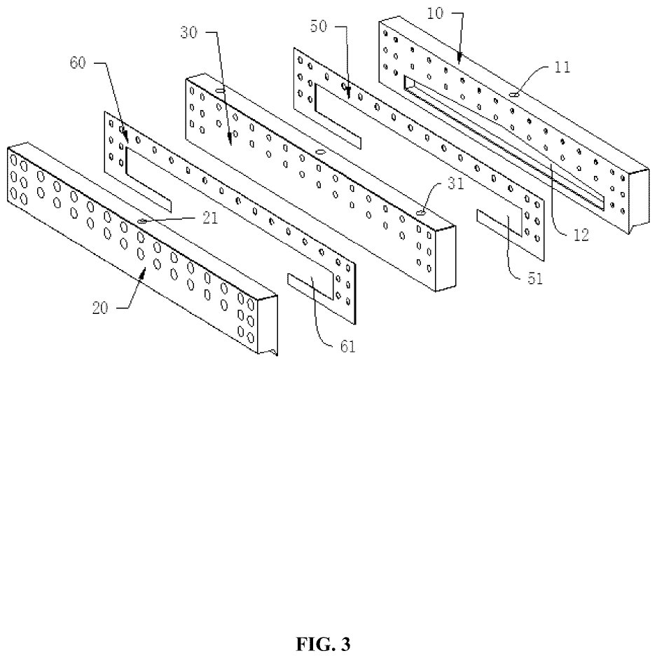

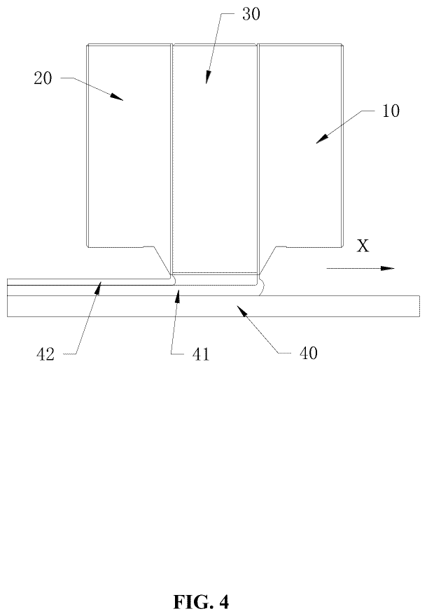

FIG. 1 is a schematic structural diagram illustrating an exemplary device for multi-layer slot die coating from a first angle according to some embodiments of the present disclosure. FIG. 2 is a schematic structural diagram illustrating a device for multi-layer slot die coating from a second angle according to some embodiments of the present disclosure. FIG. 3 is a schematic diagram illustrating an exploded structure of a device for multi-layer slot die coating according to some embodiments of the present disclosure. FIG. 4 is a schematic diagram illustrating a coating principle of a device for multi-layer slot die coating according to some embodiments of the present disclosure.

Some embodiments of the present disclosure provide a device for multi-layer slot die coating (hereinafter referred to as a coating device). As shown in FIGS. 1-4, the coating device may include a first coating die 10, a second coating die 20, and a drying module 30. One end of the first coating die 10 may be connected with a first paste, and the other end of the first coating die 10 may be configured to coat the first paste onto a substrate 40 to form a first coating layer 41. One end of the second coating die 20 may be connected with a second paste, and the other end of the second coating die 20 may be configured to coat the second paste onto the substrate 40 to form a second coating layer 42. The second coating layer 42 may be coated on a surface of the first coating layer 41. The drying module 30 may be disposed between the first coating die 10 and the second coating die 20 and configured to dry the surface of the first coating layer 41 such that a solid coating interface that causes the first coating layer 41 and the second coating layer 42 not to interfere with each other may be formed between the first coating layer 41 and the second coating layer 42.

The second coating die 20, the drying module 30, and the first coating die 10 may be sequentially arranged along a positive coating direction of the substrate 40. In some embodiments, the positive coating direction may be represented by an X-direction shown in FIG. 4.

The first coating die 10 and the second coating die 20 are components of the coating device for coating the substrate 40. The first coating die 10 and the second coating die 20 may be designed in various structural shapes such as a rectangle, a trapezoid, etc.

In some embodiments, one end of the first coating die 10 and one end of the second coating die 20 may be connected with a paste, respectively, and the other end of the first coating die 10 and the other end of the second coating die 20 may be configured to coat the paste onto the substrate 40. For example, one end of the first coating die 10 may be connected with the first paste, and the other end of the first coating die 10 may be configured to coat the first paste onto the substrate 40 to form the first coating layer 41. As another example, one end of the second coating die 20 may be connected with the second paste, and the other end of the second coating die 20 may be configured to coat the second paste onto the surface of the first coating layer 41 to form the second coating layer 42.

The paste refers to a liquid or semi-solid material used for coating, which contains components such as a solvent, a resin, a filler, an additive, etc., determining the properties and performance of the substrate 40 after coating. The first paste refers to a paste used to form the first coating layer 41 on the substrate 40, and the second paste refers to a paste used to form the second coating layer 42 on the first coating layer 41. It should be understood that the first paste and the second paste may be selected according to actual needs and may be the same or different.

The first coating layer 41 refers to a coating layer formed by solid substances left after the first coating die 10 coats the first paste onto the substrate 40 and the solvent in the first paste evaporates. The second coating layer 42 refers to a coating layer formed by solid substances left after the second coating die 20 coats the second paste onto the first coating layer 41 and the solvent in the second paste evaporates. In some embodiments, a thickness of the first coating layer 41 and a thickness of the second coating layer 42 may be determined according to actual application requirements.

It should be noted that the first coating die 10 and the second coating die 20 in this embodiment not only represent two dies, but also are two of the dies arranged front and back along the positive coating direction of the device for multi-layer slot die coating. That is, this embodiment can realize continuous coating of two to a plurality of coating layers, which greatly saves production cost and production time for products with a low coating film thickness and a volatile coating material.

The drying module 30 is a component of the coating device for drying the coating layer (e.g., the first coating layer 41) on the surface of the substrate 40. In some embodiments, the drying module 30 may be disposed between the first coating die 10 and the second coating die 20. A slot may be formed between the first coating die 10 and the drying module 30, and a slot may be formed between the second coating die 20 and the drying module 30.

In some embodiments, the drying module 30 may dry the surface of the first coating layer 41 by blowing, heating, etc., such that the solid coating interface that causes the first coating layer 41 and the second coating layer 42 not to interfere with each other may be formed between the first coating layer 41 and the second coating layer 42. The solid coating interface refers to a contact interface between the first coating layer 41 and the second coating layer 42.

The substrate 40 refers to a base material to be coated, which is a carrier for receiving a coating layer. For example, the substrate 40 may include a film, a backing paper, etc.

More descriptions regarding the device for multi-layer slot die coating may be found in the related descriptions below.

According to the device for multi-layer slot die coating provided in some embodiments of the present disclosure, by providing the drying module 30 between the first coating die 10 and the second coating die 20, the first coating layer 41 can be dried immediately after being coated, and then the second coating layer 42 is coated, such that continuous coating of a plurality of coating layers can be realized, thereby achieving multi-layer slot die coating, and saving cost and production time. Meanwhile, the drying of the drying module 30 forms the solid coating interface between the first coating layer 41 and the second coating layer 42 that causes the first coating layer 41 and the second coating layer 42 not to interfere with each other, which can prevent the first coating layer 41 and the second coating layer 42 from penetrating into each other in a wet film state to the greatest extent, and can obtain a double-layer high-quality coating film with individual interface characteristics. Furthermore, the device for multi-layer slot die coating can be applied to a coating machine to manufacture perovskite thin-film solar cells, lithium batteries, coatings, display device materials, etc.

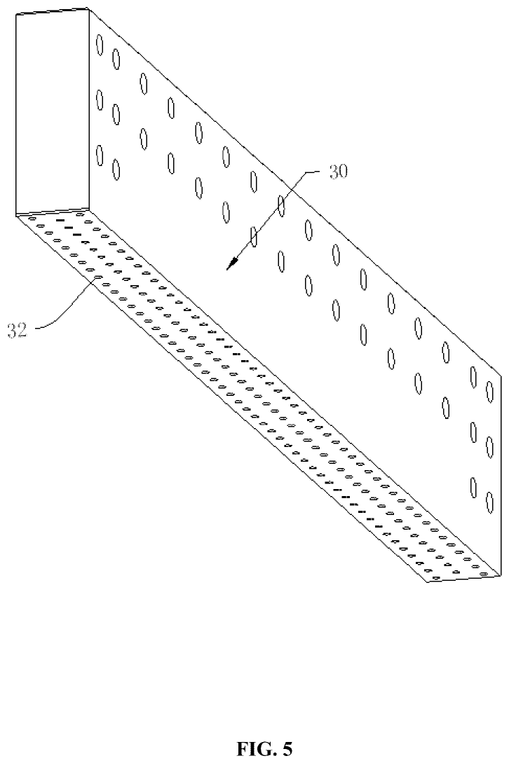

FIG. 5 is a schematic structural diagram illustrating a drying module in FIG. 1.

In some embodiments, as shown in FIG. 5, one or more gas inlets 31 may be disposed at one end of the drying module 30 and configured to receive an external heated gas. An exhaust vent 32 may be disposed at the other end of the drying module 30. The exhaust vent 32 may be opposite to the first coating layer 41 and configured to release the external heated gas to dry the surface of the first coating layer 41.

The gas inlet 31 is a hole structure for the drying module 30 to receive the external heated gas. In some embodiments, one or more gas inlets 31 may be provided. As shown in FIG. 5, three gas inlets 31 may be evenly spaced at one end of the drying module 30. In some embodiments, the one or more gas inlets 31 may be connected with an external gas supply unit (not shown in the figure) to receive the external heated gas.

The gas supply unit refers to a device or equipment for providing heated gas. In some embodiments, the gas supply unit may be provided with a heating component, a temperature control component, and a volume adjustment component. The heating component may be configured to heat gas (e.g., air or an inert gas, etc.). The temperature control component may be configured to adjust a temperature of the heated gas according to coating characteristics and product requirements. The volume adjustment component may be configured to control a real-time input volume of the heated gas according to demand.

The exhaust vent 32 is a hole structure of the drying module 30 for releasing the heated gas to dry the surface of the first coating layer 41. In some embodiments, the exhaust vent 32 may be provided with a plurality of exhaust vent holes arranged in an array and configured to output the heated gas with a low speed and a large volume.

It should be noted that the counts, positions, structural shapes, and structural sizes of the gas inlets 31 and the exhaust vent 32 may be designed according to actual conditions.

In some embodiments of the present disclosure, the drying module 30 can quickly dry the first coating layer 41 by using the gas inlets 31 to connect the external heated gas and releasing the heated gas to the first coating layer 41 on the substrate 40 through the plurality of exhaust vent holes arranged in an array, thereby forming the solid coating interface that causes the first coating layer 41 and the second coating layer 42 not to interfere with each other between the first coating layer 41 and the second coating layer 42 more quickly, and improving product quality.

In some embodiments, as shown in FIG. 1, a first pointed portion 13 may be disposed at the other end of the first coating die 10, and a first slot 101 may be disposed at a tip of the first pointed portion 13. A second pointed portion 23 may be disposed at the other end of the second coating die 20, and a second slot 201 may be disposed at a tip of the second pointed portion 23.

The first pointed portion 13 is a portion of an end of the first coating die 10 close to the substrate 40 that protrudes towards the substrate 40. The first slot 101 refers to a gap or a slit between the first coating die 10 and the drying module 30.

Similarly, the second pointed portion 23 is a portion of an end of the second coating die 20 close to the substrate 40 that protrudes towards the substrate 40. The second slot 201 refers to a gap or a slit between the second coating die 20 and the drying module 30.

In some embodiments, the slot (e.g., the first slot 101 and the second slot 201) being disposed at the tip of the pointed portion (e.g. the first pointed portion 13 and the second pointed portion 23) means that the slot is located at the topmost of an end of at least one of the pointed portion or the drying module 30 close to the substrate 40. It can be understood that disposing the slot at the tip of the pointed portion is conducive to uniform coating, such that the coating layer does not interfere with other positions of the die, and the coating quality of the first coating layer 41 and the second coating layer 42 can be guaranteed.

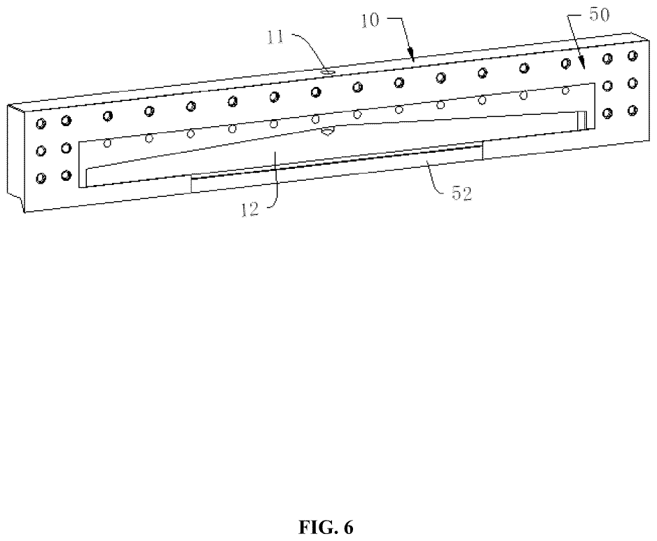

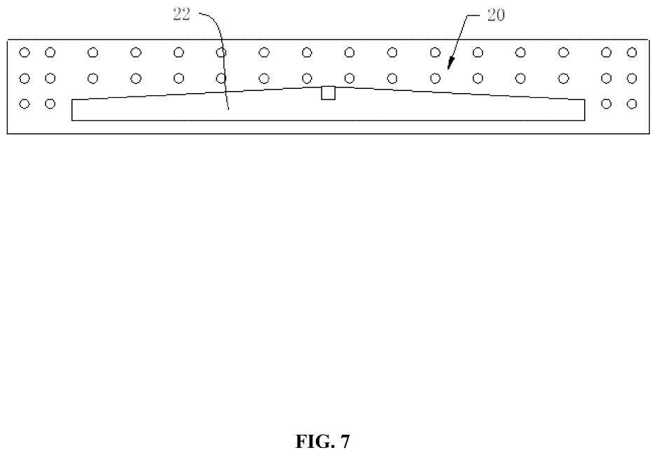

FIG. 6 is a schematic diagram illustrating a combined structure of a first coating die and a first coating gasket in FIG. 3. FIG. 7 is a schematic structural diagram illustrating a second coating die in FIG. 3.

In some embodiments, as shown in FIGS. 6-7, the first coating die 10 may include a first liquid inlet 11 and a first paste tank cavity 12. The first liquid inlet 11 may be configured to input a first paste. One end of the first paste tank cavity 12 may be connected with the first liquid inlet 11, and the first slot 101 may be formed between the other end of the first paste tank cavity 12 and the drying module 30. The first slot 101 may be configured to coat the first paste onto the substrate 40 to form the first coating layer 41.

The first liquid inlet 11 is a hole structure for the first coating die 10 to input the first paste. The first paste tank cavity 12 is a cavity for the first coating die 10 to temporarily store and accommodate the first paste. In some embodiments, the first paste tank cavity 12 may be arranged along an axial direction of the first coating die 10, and an end of the first paste tank cavity 12 away from the substrate 40 may be communicated with the first liquid inlet 11. The first paste may enter the first paste tank cavity 12 through the first liquid inlet 11 for temporary storage. The first slot 101 may formed between an end of the first paste tank cavity 12 close to the substrate 40 and the drying module 30.

In some embodiments, the second coating die 20 may include a second liquid inlet 21 and a second paste tank cavity 22. The second liquid inlet 21 may be configured to input a second paste. One end of the second paste tank cavity 22 may be connected with the second liquid inlet 21, and the second slot 201 may be formed between the other end of the second paste tank cavity 22 and the drying module 30. The second slot 201 may be configured to coat the second paste onto the substrate 40 to form the second coating layer 42.

It should be understood that the second liquid inlet 21 and the first liquid inlet 11, and the second paste tank cavity 22 and the first paste tank cavity 12 have similar effects and configurations, which are not repeated here.

In some embodiments, the first coating die 10 and the second coating die 20 may have the same structure. The first liquid inlet 11 and the second liquid inlet 21 may input the first paste and the second paste into the first paste tank cavity 12 and the second paste tank cavity 22, respectively, through an external injection pump. Then the first paste and the second paste may be coated onto the substrate 40 through the first slot 101 and the second slot 201, respectively, to form the first coating layer 41 and the second coating layer 42.

In some embodiments, a wedge groove surface (i.e., a first wedge groove surface) with a gradually increasing length may be disposed at a position of the first paste tank cavity 12 that is connected with the first liquid inlet 11, and a wedge groove surface (i.e., a second wedge groove surface) with a gradually increasing length may be disposed at a position of the second paste tank cavity 22 that is connected with the second liquid inlet 21. In some embodiments, the structural sizes of the first wedge groove surface and the second wedge groove surface may be the same or different.

After the paste enters the paste tank cavity, the paste needs to be processed at a uniform speed, or the paste flowing out of the slot has a turbulent flow, resulting in inconsistent flow speed, thus affecting the coating thickness after coating. The wedge groove surfaces make the first paste tank cavity 12 and the second paste tank cavity 22 form a hanger-shaped tank cavity, respectively, which can make the flow speed of the coating liquid (i.e., the paste) flowing out of the slot uniform, such that the thickness of the wet film after coating is uniform.

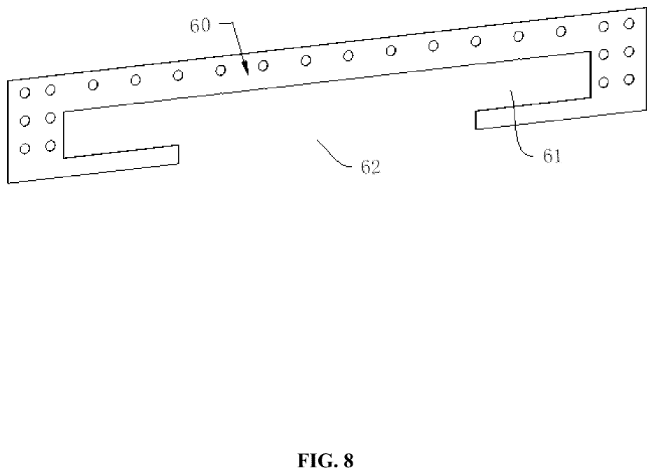

FIG. 8 is a schematic structural diagram illustrating a second coating gasket in FIG. 3.

As shown in FIG. 3, FIG. 6, and FIG. 8, the device for multilayer slot die coating may further include a first coating gasket 50 and a second coating gasket 60. The first coating gasket 50 may be disposed between the first coating die 10 and the drying module 30. The second coating gasket 60 may be disposed between the second coating die 20 and the drying module 30.

The first coating gasket 50 is a sheet structure disposed between the first coating die 10 and the drying module 30 and is configured to form the first slot 101.

The second coating gasket 60 is a sheet structure disposed between the second coating die 20 and the drying module 30 and is configured to form the second slot 201.

In some embodiments, the first coating die 10, the first coating gasket 50, and the drying module 30 may be fixedly connected through a fastener (i.e., a first fastener). The second coating die 20, the second coating gasket 60, and the drying module 30 may be fixedly connected through another fastener (i.e., a second fastener). It can be understood that the first coating die 10, the first coating gasket 50, the drying module 30, the second coating gasket 60, and the second coating die 20 may be respectively provided with fastening holes for connecting fasteners. The fasteners may be screws, etc., and detachable connection may be realized through the fasteners, which facilitates disassembly and mounting of each component, and is convenient for cleaning and adjusting the count of dies according to the count of coating layers required.

It should be noted that the first coating die 10, the first coating gasket 50, and the drying module 30, and the second coating die 20, the second coating gasket 60, and the drying module 30 may also be fixedly connected, respectively, by any other feasible means, such as snap-fit connection.

In some embodiments, the first coating gasket 50 may be provided with a first tank cavity hole 51 and a first liquid outlet 52. The first tank cavity hole 51 may be communicated with the first paste tank cavity 12. One end of the first liquid outlet 52 may be communicated with the first tank cavity hole 51, and the other end of the first liquid outlet 52 may be opposite to the substrate 40 to form the first slot 101.

The second coating gasket 60 may be provided with a second tank cavity hole 61 and a second liquid outlet 62. The second tank cavity hole 61 may be communicated with the second paste tank cavity 22. One end of the second liquid outlet 62 may be communicated with the second tank cavity hole 61, and the other end of the second liquid outlet 62 may be opposite to the substrate 40 to form the second slot 201.

The first coating gasket 50 and the second coating gasket 60 may have the same structure. In actual production, a width of the first paste tank cavity 12 may be the same as a width of the first tank cavity hole 51, and may be greater than a width of the first liquid outlet 52. A width of the second paste tank cavity 22 may be the same as a width of the second tank cavity hole 61, and may be greater than a width of the second liquid outlet 62. In this way, there is sufficient paste for coating at the liquid outlet, thereby improving the uniformity of paste coating.

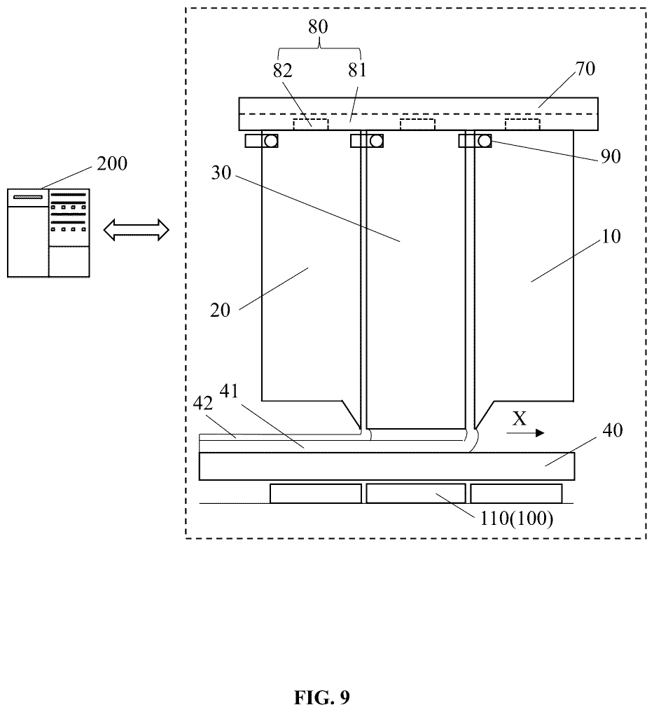

FIG. 9 is a schematic structural diagram illustrating another exemplary device for multi-layer slot die coating according to some embodiments of the present disclosure.

In some embodiments, as shown in FIG. 9, the coating device may further include a slot control module (not shown in the figure). The slot control module may include a base 70 and a moving mechanism 80. The moving mechanism 80 may be fixedly connected with the base 70. The moving mechanism 80 may be configured to drive the second coating die 20, the drying module 30, and the first coating die 10 to move on the base 70.

The base 70 is a component of the coating device for fixing and mounting the moving mechanism 80. The structural shape of the base 70 may be designed according to an actual structure to facilitate the mounting of the moving mechanism 80. For example, the structural shape of the base 70 may include a flat plate shape or a combination of other structural shapes.

The moving mechanism 80 is a component of the coating device for driving the second coating die 20, the drying module 30, and the first coating die 10 to move on the base 70. For example, the moving mechanism 80 may include a combination of a motor and a slider guide rail mechanism, a hydraulic pump, etc.

In some embodiments, the moving mechanism 80 may be disposed on the base 70 along the positive coating direction to drive the first coating die 20, the drying module 30, and the first coating die 10 to move on the base 70 along the positive coating direction.

In some embodiments, the moving mechanism 80 may be arranged corresponding to the second coating die 20, the drying module 30, and the first coating die 10. That is, the second coating die 20, the drying module 30 and the first coating die 10 may be respectively connected with one moving mechanism 80 so as to move independently on the base 70. It can be understood that when the moving mechanism 80 adopts the combination of the motor and the slider guide rail mechanism, a plurality of moving mechanisms 80 may share one guide rail 81, i.e., a plurality of sliders 82 may be clamped in one guide rail 81.

Merely by way of example, as shown in FIG. 9, the moving mechanism 80 may adopt the combination of the motor and the slider guide rail mechanism. The sliders 82 may be arranged corresponding to the second coating die 20, the drying module 30, and the first coating die 10 (e.g., three sliders 82 are provided), and the guide rail 81 may be arranged on the base 70 along the positive coating direction. One end of each of the three sliders 82 may be clamped in the guide rail 81, and the other end of each of the three sliders 82 may be fixedly connected with the second coating die 20, the drying module 30, and the first coating die 10, respectively. The three sliders 82 may be respectively connected with output ends of three motors. The motors may rotate to drive the sliders 82 to move in the guide rail 81, so as to drive the second coating die 20, the drying module 30, and the first coating die 10 to move on the base 70.

In some embodiments of the present disclosure, the slot control module is provided to drive the second coating die 20, the drying module 30, and the first coating die 10 to move freely on the base 70, so as to adjust the positions of the first coating die 10, the second coating die 20, and the drying module 30, and adjust widths of the first slot 101 and the second slot 201, thereby adapting to various coating requirements.

In some embodiments, as shown in FIG. 9, the coating device may further include a limiting member 90 configured to constrain the positions of the second coating die 20, the drying module 30, and the first coating die 10 on the base 70.

The limiting member 90 refers to a member used to constrain the positions of the second coating die 20, the drying module 30, and the first coating die 10 on the base 70. For example, the limiting member 90 may include but is not limited to a locking buckle, etc.

In some embodiments, the limiting member 90 may be disposed on the second coating die 20, the drying module 30, and the first coating die 10. In response to determining that the second coating die 20, the drying module 30, and the first coating die 10 move to a preset position, the limiting member 90 may rotate and connect with the base 70 to lock the second coating die 20, the drying module 30, and the first coating die 10, so as to constrain the second coating die 20, the drying module 30, and the first coating die 10 to the preset position. The preset position may be determined according to actual coating requirements (e.g., the requirements of the first slot and the second slot).

In some embodiments, the limiting member 90 may also be disposed on the base 70 in any other feasible mode to realize the function of constraining the positions of the second coating die 20, the drying module 30, and the first coating die 10 on the base 70.

In some embodiments of the present disclosure, by providing the limiting member 90, the second coating die 20, the drying module 30 and the first coating die 10 may be locked after the second coating die 20, the drying module 30, and the first coating die 10 move to the preset position, which ensures that the widths of the first slot 101 and the second slot 201 remain constant.

In some embodiments, as shown in FIG. 9, the coating device may further include a heating component 100. The heating component 100 may be disposed at a bottom of the substrate 40 and may be configured to cooperate with the drying module 30 to dry the first coating layer 41.

The heating component 100 refers to a device or equipment for assisting in drying the first coating layer 41. For example, the heating component 100 may include but is not limited to a resistance wire, etc.

In some embodiments, the heating assembly 100 may include a plurality of heating units 110. The plurality of heating units 110 may be sequentially arranged at the bottom of the substrate 40 along the positive coating direction to cooperate with the drying module 30 to dry the first coating layer 41. In response to determining that the drying module 30 moves to a first position, the heating unit 110 at the first position may start heating, and the drying module 30 and the heating unit 110 may simultaneously dry the first coating layer 41. In response to determining that the drying module 30 leaves the first position and reaches the second position, the heating unit 110 at the first position stops heating.

In some embodiments of the present disclosure, the heating component 100 may be provided at the bottom of the substrate 40 to cooperate with the drying module 30 to simultaneously dry the first coating layer 41, thereby effectively improving the drying effect and preventing the two coating layers from penetrating into each other in the wet film state to the greatest extent, and obtaining a double-layer high-quality coating film with individual interface characteristics.

In some embodiments, as shown in FIG. 9, the coating device may further include a control module 200. The control module may be electrically connected with the drying module 30 and the heating component 100.

The control module 200 refers to a module for controlling the operation of other components or mechanisms of the coating device. For example, the control module 200 may include but is not limited to an operation console, etc. In some embodiments, the control module 200 may include a processor.

The processor may be configured to process at least one of data or information obtained from other device components. The processor may execute program instructions based on at least one of the data, information, or processing results to perform one or more functions described in the present disclosure. In some embodiments, the processor may include one or more sub-processing devices (e.g., a single-core processing device or a multi-core processing device). Merely by way of example, the processor may include a central processing unit (CPU), a controller, a microcontroller unit, a microprocessor, or the like, or any combination thereof.

In some embodiments, the control module 200 may be configured to obtain a first paste feature, a first coating thickness, a product requirement, and a coating speed; determine a drying parameter based on the first paste feature, the first coating thickness, the product requirement, and the coating speed; and control at least one of the drying module or the heating component to perform drying based on the drying parameter.

In some embodiments, the control module 200 may be further configured to determine the first coating thickness based on a first slot width, a paste viscosity, and a paste pressure.

It should be noted that the control module 200 may be arranged on the coating device, or may be independently arranged outside the coating device. In some embodiments, the control module 200 may be in communication with the coating device to remotely control the relevant components of the coating device. More descriptions regarding the control module may be found in the related descriptions below.

In some embodiments of the present disclosure, by providing the control module 200, the coating device may be controlled by integrating various data, thereby effectively improving the coating effect of the coating device.

Referring to FIG. 4, some embodiments of the present disclosure further provide a coating method, implemented using the device for multi-layer slot die coating. In some embodiments, the coating method may be implemented by the control module of the coating device. The coating method may include the following operations.
S1: the device for multi-layer slot die coating may be moved along the positive coating direction of the substrate 40, the first coating die 10, the drying module 30, and the second coating die 20 moving simultaneously;
S2: in response to determining that the first coating die 10 moves to a first position of the substrate 40, the first coating die 10 may start to coat the first coating layer 41, the first position being preset by an operator;
S3: in response to determining that the drying module 30 moves to the first position, the drying module 30 may start to dry the surface of the first coating layer 41;
S4: in response to determining that the second coating die 20 moves to the first position, the second coating die 20 may start to coat the second coating layer 42 on the surface of the first coating layer 41 after drying;
S5: in response to determining that the first coating die 10 moves to a second position of the substrate 40, the first coating die 10 may be turned off, and the coating of the first coating layer 41 may be completed, the second position being preset by the operator;
S6: in response to determining that the drying module 30 moves to the second position of the substrate 40, the drying module 30 may be turned off, and the drying of the surface of the first coating layer 41 may be completed;
S7: in response to determining that the second coating die 20 moves to the second position of the substrate 40, the second coating die 20 may be turned off, and the coating of the second coating layer 42 may be completed.

The coating method provided in some embodiments of the present disclosure can perform continuous coating of a plurality of coating layers. The first coating layer 41 can be dried immediately after the coating is completed using the drying module 30 disposed between the coating dies. In this way, most of the solvent in the first coating layer 41 is evaporated to form a homogeneous dry film before the second coating layer 42 is coated, and a multi-layer high-quality coating film with individual interface characteristics is obtained. In addition, the coating method can provide more choices of raw materials and coating processes for multi-layer coating pastes and develop a larger window. The coating method is suitable for process techniques with thin coating films and volatile coating materials, such as multi-layer solution coating in the display industry and perovskite thin-film photovoltaic cell industry.

In some embodiments, the coating device may further include the heating component and the control module. The control module may be electrically connected with the drying module 30 and the heating component. More descriptions regarding the heating component and the control module may be found in the related descriptions above.

In some embodiments, in response to determining that the drying module 30 moves to the first position, the drying module 30 may start to dry the surface of the first coating layer 41 (i.e., S3), including the following operations.
S31: a first paste feature, a first coating thickness, a product requirement, and a coating speed may be obtained.

The coating speed refers to a moving speed of the first coating die 10. In some embodiments, the coating speed may be determined by an operator based on past experience or the like, and may be obtained through input.

The product requirement refers to a requirement for a degree of mutual independence of the first coating layer 41 and the second coating layer 42. In some embodiments, the product requirement may be expressed in the form of grades or numerical values. For example, the higher the numerical value, the higher the degree of mutual independence. Merely by way of example, the numerical unit is 1-3, where 1 means that it is acceptable for the two coating layers to have a certain penetration (e.g., a penetration thickness is less than ½ of the thickness of the first coating layer); 2 means that the two coating layers can only have a slight penetration (e.g., the penetration thickness is less than ¼ of the thickness of the first coating layer); and 3 means that the two coating layers cannot penetrate into each other at all. In some embodiments, the product requirement may be obtained through operator input.

The first paste feature refers to a feature related to the first paste, such as a paste viscosity, a solid content, etc. In some embodiments, the first paste feature may include the paste viscosity. The paste viscosity refers to the resistance shown by the first paste during the flow process. In some embodiments, the first paste feature may be obtained through operator input.

The first coating thickness refers to thickness information of the first coating layer 41. In some embodiments, the first coating thickness may be determined in various ways. For example, the first coating thickness may be preset by an operator.

In some embodiments, the control module may determine the first coating thickness based on the first slot width, the paste viscosity, the coating speed, and the paste pressure.

The first slot width refers to a width of a gap or a slit between the first coating die 10 and the drying module 30. In some embodiments, the first slot width may be obtained through operator input.

The paste pressure refers to a pressure exerted on the first paste at the first slot 101. In some embodiments, the paste pressure may be measured by a monitoring component. For example, the monitoring component may be a pressure sensor. The pressure sensor may be disposed at the first pointed portion 13 to directly measure the paste pressure and transmit the paste pressure to the control module in real time. As another example, the monitoring component may be a liquid level sensor. The liquid level sensor may be disposed in the first paste tank cavity 12 to measure a paste height in the first paste tank cavity 12. Then the paste pressure may be determined through a comparison table based on the paste height.

The comparison table may be configured to characterize a correspondence relationship between the paste height and the paste pressure. In some embodiments, the comparison table may be constructed based on historical data.

In some embodiments, the control module may determine the first coating thickness by querying a first preset table based on the first slot width, the paste viscosity, the coating speed, and the paste pressure.

The first preset table may be configured to characterize a correspondence relationship between the first coating thickness and the first slot width, the paste viscosity, the coating speed, and the paste pressure. Each set of first slot width, paste viscosity, coating speed and paste pressure may correspond to a first coating thickness. In some embodiments, the first preset table may be constructed based on historical data.

In some embodiments of the present disclosure, the first coating thickness may be determined by comprehensively considering a plurality of parameters such as the first slot width, the paste viscosity, the coating speed, and the paste pressure, such that the first coating thickness can be more reasonable.
S32: a drying parameter may be determined based on the first paste feature, the first coating thickness, the product requirement, and the coating speed.

The drying parameter refers to a relevant parameter used to control the drying module 30 and the heating component. In some embodiments, the drying parameter may include a heating temperature of the temperature control component, a real-time input volume of the volume adjustment component, and a heating temperature of the heating component.

In some embodiments, the control module may determine the drying parameter by querying a second preset table based on the first paste feature, the first coating thickness, the product requirement, and the coating speed. The second preset table may be used to characterize a correspondence relationship between the drying parameter and the first paste feature, the first coating thickness, the product requirement, and the coating speed. Each set of first paste feature, first coating thickness, product requirement and coating speed may correspond a drying parameter. In some embodiments, the second preset table may be constructed based on historical data. For example, different drying parameters may be set for the first paste feature, the first coating thickness, and the coating speed in the historical data. After the coating is completed, a plurality of penetration effects may be obtained, and then drying parameters that meet product requirements of a plurality of different levels and corresponding product requirements may be combined with the first paste feature, the first coating thickness, and the coating speed to obtain the second preset table. The penetration effect may be detected by ultrasonic detection or penetration detection.

In some embodiments, the control module may determine the drying parameter through a prediction model based on the first paste feature, the first coating thickness, the product requirement, and the coating speed.

The prediction model refers to a model used to determine the drying parameter. In some embodiments, the prediction model may be a machine learning model. For example, the prediction model may include a deep neural network (DNN) model, or other custom models, or any combination thereof.

In some embodiments, an input of the prediction model may include the first paste feature, the first coating thickness, the product requirement, and the coating speed, and an output of the prediction model may include may include the drying parameter.

In some embodiments, the prediction model may be trained based on a large number of training samples with labels. The training samples may include a sample first paste feature, a sample first coating thickness, a sample product requirement, and a sample coating speed. The labels may include an actual drying parameter corresponding to the training samples.

In some embodiments, the training samples may be determined based on the historical data. The labels may be determined in a manner similar to the construction of the second preset table above, which is not repeated here.

In some embodiments, the control module may input the training samples into an initial prediction model, iteratively update parameters of the initial prediction model through training until the trained initial prediction model meets a preset condition, and obtain a trained prediction model. The preset condition may be that a loss function is less than a threshold or converges, a training cycle reaches a threshold, etc. In some embodiments, the manner of iteratively updating the parameters of the prediction model may include conventional model training manners such as stochastic gradient descent, etc. In some embodiments, the loss function may be constructed based on differences between the outputs of the initial prediction model and the labels.
S33: at least one of the drying module or the heating component may be controlled to perform drying based on the drying parameter.

In some embodiments, the control module may control the drying module 30 and the heating component respectively to dry the first coating layer 41 by generating a corresponding control instruction based on the drying parameter. For example, the control module may generate a first temperature adjustment instruction and a volume adjustment instruction based on the drying parameter to control the temperature control component and the volume adjustment component of the drying module 30 respectively to operate at the heating temperature of the temperature control component and at the real-time input volume of the volume adjustment component in the drying parameter. As another example, the control module may generate a second temperature adjustment instruction based on the drying parameter to control the heating component to operate at the heating temperature of the heating component in the drying parameter.

In some embodiments of the present disclosure, the reasonable drying parameter may be determined by comprehensively considering a plurality of parameters such as the first paste feature, the first coating thickness, the product requirement, and the coating speed, thereby effectively ensuring that the drying effect of the first coating layer meets the product requirement.

The above embodiments only express several implementation methods of the present disclosure, and the descriptions thereof are relatively specific and detailed, but they cannot be understood as limiting the scope of the present disclosure. It should be noted that for those having ordinary skills in the art, several modifications and improvements can be made without departing from the concept of the present disclosure, and these modifications and improvements belong to the protection scope of the present disclosure. Therefore, the protection scope of the present disclosure shall be subject to the attached claims.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure and are within the spirit and scope of the exemplary embodiments of the present disclosure.

What is claimed is:

1. A device for multi-layer slot die coating, comprising:
a first coating die, one end of the first coating die being connected with a first paste, and the other end of the first coating die being configured to coat the first paste onto a substrate to form a first coating layer;
a second coating die, one end of the second coating die being connected with a second paste, and the other end of the second coating die being configured to coat the second paste onto the substrate to form a second coating layer, the second coating layer being coated on a surface of the first coating layer; and
a drying module disposed between the first coating die and the second coating die and configured to dry the surface of the first coating layer such that a solid coating interface that causes the first coating layer and the second coating layer not to interfere with each other is formed between the first coating layer and the second coating layer; wherein
the second coating die, the drying module, and the first coating die are sequentially arranged along a positive coating direction of the substrate.

2. The device of claim 1, wherein one or more gas inlets are disposed at one end of the drying module and are configured to receive an external heated gas, an exhaust vent is disposed at the other end of the drying module, and the exhaust vent is opposite to the first coating layer and is configured to release the external heated gas to dry the surface of the first coating layer.

3. The device of claim 2, wherein the exhaust vent is provided with a plurality of exhaust vent holes arranged in an array.

4. The device of claim 1, wherein the first coating die includes a first liquid inlet and a first paste tank cavity, the first liquid inlet is configured to input the first paste, one end of the first paste tank cavity is connected with the first liquid inlet, a first slot is formed between the other end of the first paste tank cavity and the drying module, and the first slot is configured to coat the first paste onto the substrate to form the first coating layer;
the second coating die includes a second liquid inlet and a second paste tank cavity, the second liquid inlet is configured to input the second paste, one end of the second paste tank cavity is connected with the second liquid inlet, a second slot is formed between the other end of the second paste tank cavity and the drying module, and the second slot is configured to coat the second paste onto the substrate to form the second coating layer.

5. The device of claim 4, wherein a first wedge groove surface is disposed at a position of the first paste tank cavity that is connected with the first liquid inlet, and a second wedge groove surface is disposed at a position of the second paste tank cavity that is connected with the second liquid inlet.

6. The device of claim 4, wherein a first pointed portion is disposed at the other end of the first coating die, the first slot is disposed at a tip of the first pointed portion, a second pointed portion is disposed at the other end of the second coating die, and the second slot is disposed at a tip of the second pointed portion.

7. The device of claim 4, further comprising a first coating gasket and a second coating gasket, wherein the first coating gasket is arranged between the first coating die and the drying module, and the second coating gasket is arranged between the second coating die and the drying module.

8. The device of claim 7, wherein the first coating die, the first coating gasket, and the drying module are fixedly connected through a first fastener; and the second coating die, the second coating gasket, and the drying module are fixedly connected through a second fastener.

9. The device of claim 7, wherein the first coating gasket is provided with a first tank cavity hole and a first liquid outlet, the first tank cavity hole is communicated with the first paste tank cavity, one end of the first liquid outlet is communicated with the first tank cavity hole, and the other end of the first liquid outlet is opposite to the substrate to form the first slot;
the second coating gasket is provided with a second tank cavity hole and a second liquid outlet, the second tank cavity hole is communicated with the second paste tank cavity, one end of the second liquid outlet is communicated with the second tank cavity hole, and the other end of the second liquid outlet is opposite to the substrate to form the second slot.

10. The device of claim 1, further comprising a slot control module, wherein the slot control module includes a base and a moving mechanism, and the moving mechanism is fixedly connected with the base;
the moving mechanism is configured to drive the second coating die, the drying module, and the first coating die to move on the base.

11. The device of claim 10, further comprising a limiting member, wherein the limiting member is configured to constrain positions of the second coating die, the drying module, and the first coating die on the base.

12. The device of claim 1, further comprising a heating component, wherein the heating component is disposed at a bottom of the substrate and is configured to cooperate with the drying module to dry the first coating layer.

13. The device of claim 12, further comprising a control module, wherein the control module is electrically connected with the drying module and the heating component; and
the control module is configured to:
acquire a first paste feature, a first coating thickness, a product requirement, and a coating speed, the first paste feature including a paste viscosity;
determine a drying parameter based on the first paste feature, the first coating thickness, the product requirement, and the coating speed; and
control at least one of the drying module or the heating component to perform drying based on the drying parameter.

14. The device of claim 13, wherein the control module is further configured to:
determine the first coating thickness based on a first slot width, the paste viscosity, the coating speed, and a paste pressure.

15. A coating method of a device for multi-layer slot die coating, implemented based on the device for multi-layer slot die coating of claim 1, comprising:
moving the device for multi-layer slot die coating along the positive coating direction of the substrate, wherein the first coating die, the drying module, and the second coating die move simultaneously;
in response to determining that the first coating die moves to a first position of the substrate, the first coating die starting to coating the first coating layer;
in response to determining that the drying module moves to the first position, the drying module starting to dry the surface of the first coating layer;
in response to determining that the second coating die moves to the first position, the second coating die starting to coat the second coating layer on the surface of the first coating after drying;
in response to determining that the first coating die moves to a second position of the substrate, turning off the first coating die to complete coating of the first coating layer;
in response to determining that the drying module moves to the second position of the substrate, turning off the drying module to complete drying of the surface of the first coating layer; and
in response to determining that the second coating die moves to the second position of the substrate, turning off the second coating die to complete coating of the second coating layer.

16. The coating method of claim 15, wherein the device for multi-layer slot die coating further includes a heating component and a control module, and the control module is electrically connected with the drying module and the heating component;
the in response to determining that the drying module moves to the first position, the drying module starting to dry the surface of the first coating layer includes:
acquiring a first paste feature, a first coating thickness, a product requirement, and a coating speed, the first paste feature including a paste viscosity;
determining a drying parameter based on the first paste feature, the first coating thickness, the product requirement, and the coating speed; and
controlling at least one of the drying module or the heating component to perform drying based on the drying parameter.

17. The coating method of claim 16, wherein the acquiring a first coating thickness includes:
determining the first coating thickness based on a first slot width, the paste viscosity, the coating speed, and a paste pressure.
